(19) United States
(12) Patent Application Publication
(10) Pub. No.: US 2024/0093597 A1
(43) Pub. Date: Mar. 21, 2024

(54) Rapid Identification of Hydrodynamic Traps in Hydrocarbon Reservoirs

(71) Applicant: Saudi Arabian Oil Company, Dhahran (SA)

(72) Inventor: Simon A. Stewart, Dhahran (SA)

(21) Appl. No.: 17/945,686

(22) Filed: Sep. 15, 2022

(51) Int. Cl. E21B 47/10; E21B 47/04

(52) U.S. Cl. CPC E21B 47/10; E21B 47/04

(57) ABSTRACT

Example computer-implemented methods, media, and systems for rapidly identifying hydrodynamic traps in hydrocarbon reservoirs are disclosed. One example computer-implemented method includes receiving a depth structure map of a geological structure associated with a subsurface reservoir. Multiple pairs of tilt value and tilt azimuth value associated with a fluid contact of the subsurface reservoir are received. A respective set of hydrodynamic traps associated with the subsurface reservoir is determined for each pair of tilt value and tilt azimuth value and based at least on the depth structure map. It is determined that there exist a common subset of hydrodynamic traps from the respective set of hydrodynamic traps of each pair of tilt value and tilt azimuth value. One or more locations of potential wells associated with the subsurface reservoir are identified based at least on the determined common subset of hydrodynamic traps.

### TECHNICAL FIELD

The present disclosure relates to computer-implemented methods, media, and systems for rapidly identifying hydrodynamic traps in hydrocarbon reservoirs.

### BACKGROUND

Pore space in a subsurface reservoir is usually filled with water. A fluid that is immiscible with water, such as oil, can also present. Immiscible fluids can be moved by buoyancy until trapped when they reach a location where no further reduction in pressure can be achieved by migration due to the configuration of the porous geological layers. Accumulations of buoyant fluids in such hydrodynamic traps are assumed as having flat boundaries, i.e., horizontal fluid contacts, with the water that fills the rest of the reservoir. However, regionally-extensive reservoirs can experience slow pore water flow. The associated flow rates can be sufficient to tilt the fluid contacts with immiscible fluid accumulations.

Methods to address the impact of these fluid contact tilts on hydrodynamic trap identification can include constructing hydraulic head maps in order to transform the depth structural map of the geological structure associated with the reservoir. However, the construction of the hydraulic head maps can be challenging in some exploration settings due to paucity of reservoir pressure data and local reservoir property variations, resulting in time-consuming workflows with high uncertainty.

### SUMMARY

The present disclosure involves computer-implemented methods, media, and systems for rapidly identifying hydrodynamic traps in hydrocarbon reservoirs. One example computer-implemented method includes receiving a depth structure map of a geological structure associated with a subsurface reservoir. Multiple pairs of tilt value and tilt azimuth value associated with a fluid contact of the subsurface reservoir are received. A respective set of hydrodynamic traps associated with the subsurface reservoir is determined for each pair of tilt value and tilt azimuth value and based at least on the depth structure map. It is determined that there exist a common subset of hydrodynamic traps from the respective set of hydrodynamic traps of each pair of tilt value and tilt azimuth value. One or more locations of potential wells associated with the subsurface reservoir are identified based at least on the determined common subset of hydrodynamic traps.

While generally described as computer-implemented software embodied on tangible media that processes and transforms the respective data, some or all of the aspects may be computer-implemented methods or further included in respective systems or other devices for performing this described functionality. The details of these and other aspects and implementations of the present disclosure are set forth in the accompanying drawings and the description below. Other features, objects, and advantages of the disclosure will be apparent from the description and drawings, and from the claims.

### BRIEF DESCRIPTION OF DRAWINGS

FIG. 1 depicts an example method for determining a hydrodynamic structure based at least on a depth structure map and regional fluid information.

FIG. 2 illustrates an example portion of a system for measuring reflected drilling acoustic signals.

FIG. 3A illustrates an example depth structure map of an area.

FIG. 3B illustrates example interactive sliders that can enable a user to specify tilt and tilt azimuth associated with a fluid contact surface.

FIG. 3C illustrates an example transformed depth structure map.

FIG. 3D illustrates an example of adding identified hydrodynamic traps to a depth structure map.

FIG. 4 illustrates an example relationship between tilt amplification factor and densities of oil and water.

FIG. 5 illustrates an example method for rapidly identifying hydrodynamic traps in hydrocarbon reservoirs.

FIG. 6 is a schematic illustration of example computer systems that can be used to execute implementations of the present disclosure.

Like reference numbers and designations in the various drawings indicate like elements.

### DETAILED DESCRIPTION

This disclosure describes technologies related to rapid identification of hydrodynamic traps for buoyant fluids such as hydrocarbons and CO₂ in subsurface reservoirs. In some implementations, the impact of fluid contact tilt on hydrodynamic trap identification can be screened rapidly without constructing hydraulic head maps, by isolating regional reservoir pore water flow rates and fluid properties of reservoir and buoyant fluids, most of which can be established using representative ranges. These representative ranges can yield locally applicable constant gradients that can be used to define a two-dimensional fluid contact plane with which to adjust the depth structure map of geological structure of a reservoir, thereby rapidly assessing hydrodynamic effects on hydrodynamic trap identification.

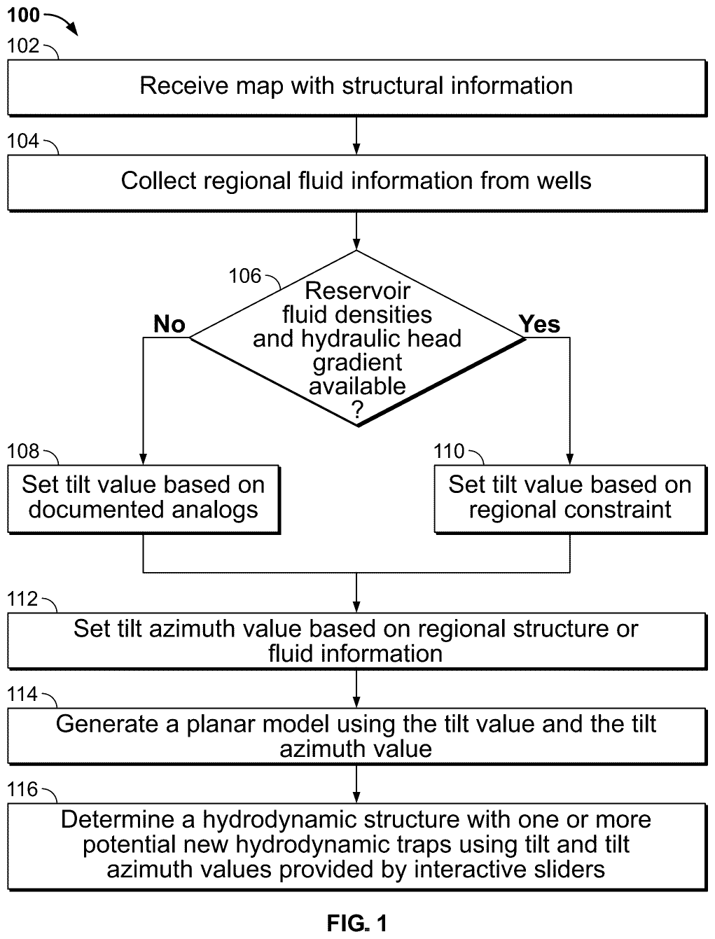

FIG. 1 depicts an example method 100 for determining a hydrodynamic structure based at least on a depth structure map and regional fluid information collected from wells in an area. In some implementations, the hydrodynamic structure can include the depth structure map of the area and identified hydrodynamic traps projected on to the depth structure map.

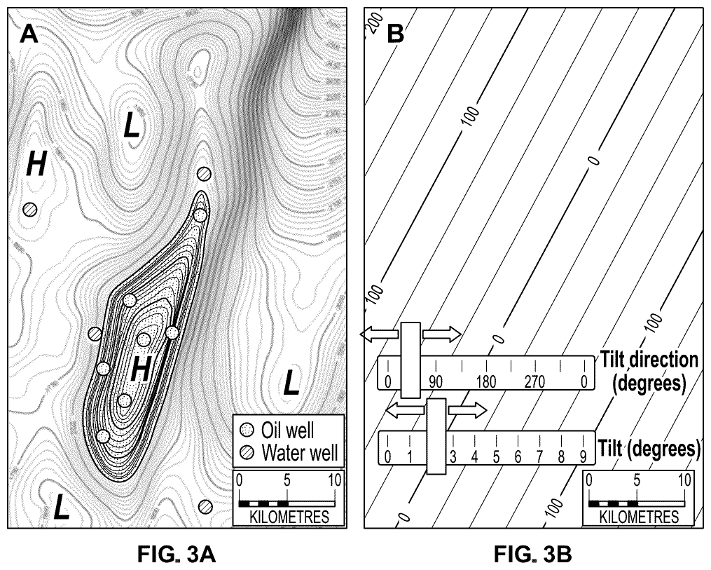

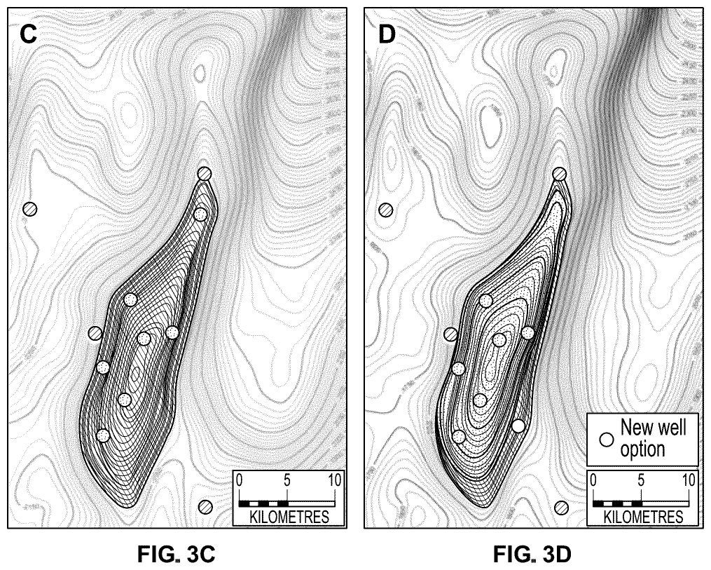

At 102, a map with subsurface structural information, also called a depth structure map, is received. The depth structure map can highlight structural highs (H) and lows (L). An example depth structure map is shown in FIG. 3A. The wells illustrated in FIG. 3A show where oil and water have been found. These wells can be used as a basis of defining an oil accumulation (the polygon), which is limited by an assumed horizontal oil-water contact fitted between the deepest oil wells and the shallowest water wells. The oil-water contact can also be called fluid contact. Regionally-extensive reservoirs can experience slow pore water flow. Although slow, these flow rates can be sufficient to tilt the fluid contact with immiscible fluid accumulations. Tilted fluid contact can impact the locations of hydrodynamic traps.

In some implementations, drilled wells that penetrate a specific porous reservoir can constrain the fluid content of that reservoir, e.g. oil, in two ways. First, by direct observation in a well. Wells can be logged by various techniques (e.g. wireline logging) that reveal, by petrophysical analysis, the fluid type. A well can provide direct observation in the form of shows, i.e. traces of oil in the well cuttings, while it is drilled through the oil-bearing reservoir, or hydrocarbon gases in the circulating coolant mud system that accompanies drilling. Fluid samples may be acquired, e.g. by Modular Dynamic Tester tool, for examination at the surface or in the lab that show exactly what fluid is present. Second, by inference from acquired data. For example, if a number of fluid pressure points are taken, e.g. by Repeat Formation Tester tool, at different depths, a fluid pressure gradient can be established that is proportional to the fluid density and hence composition (oil can have different, known, density from water or brine). Likewise, a well that penetrates a water-bearing unit will yield indications that water is present via similar techniques. Combining two such wells can determine the fluid contact between oil and water, with precision inversely proportional to the depth difference between the wells. Intersection of pressure gradients from oil and water zone wells also yields a fluid contact depth. Rarely, a fluid contact or transition zone between fluids may be directly drilled.

At 104, regional fluid information from wells in the area are collected. In some implementations, the regional fluid information can include reservoir fluid density information and hydraulic head gradient information. These two pieces of information can be used to determine the impact of reservoir water flow on fluid contact tilt.

In some implementations, the effect of reservoir water flow on fluid contact tilt depends on two parameters, the hydraulic head gradient (dh/dx) and the density contrast between the immiscible fluids (usually formulated as ρ_{w}/(ρ_{w}−ρₒ)), where ρ_{w} is reservoir water density and ρₒ is density of the immiscible fluid, e.g. oil. These factors can produce tilt of fluid contacts according to the following relationship:

$$tan θ = \frac{{ρ}_{w}}{{ρ}_{w} - {ρ}_{o}} \times \frac{dh}{dx}$$

This relationship can be used to build transformations of depth structure maps based at least on hydraulic head gradient and fluid densities. For example, representative ranges of the hydraulic head gradient and fluid densities can be used to transform depth structure maps, as described below.

In reservoirs that are regionally extensive, for example, reservoirs having at least tens of kilometers in extent of continuously connected porosity system, and are open in the sense that the reservoirs are connected to wider hydrodynamic systems for example by being partly exposed at the land surface or being connected to other reservoirs in the subsurface by geological faults or unconformities, hydraulic head gradients are generally non-zero. The case of lower or zero hydraulic head gradients is generally restricted to isolated, also known as closed, reservoir units that are enclosed by seals on all sides. Spatially-extensive reservoirs on the other hand tap into pore water pressure-influencing mechanisms that vary at basin scale, inducing a hydraulic head gradient and a range of 0.5 to 1 m/km can be used as a representative minimum range for hydraulic head gradient.

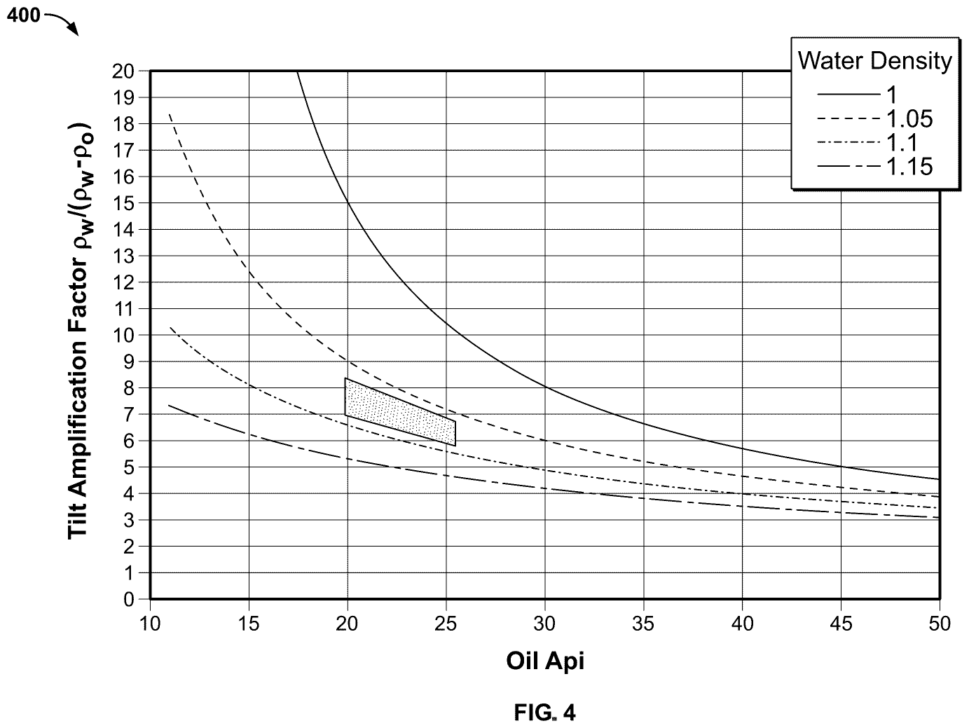

The density contrast between immiscible fluids in subsurface reservoirs is also called tilt amplification factor and is expressed as (ρ_{w}/(ρ_{w}−ρₒ)). This factor is illustrated in FIG. 4. In FIG. 4, a number of water density curves are depicted, spanning the range of water densities in representative sedimentary basins. The water density can increase as a function of dissolved solids such as sodium chloride but also vary with temperature and pressure, with a representative range of 1 to 1.15 g/cc. In FIG. 4 the immiscible fluid (oil) is shown in api units, which is the conventional measurement for oil gravity. The conversion from api gravity to specific gravity is SG=141.5/(API+131.5). An alternative version of the chart with the x-axis in units of g/cc is similar in nature.

On FIG. 4, a box illustrates how knowledge of the local fluid conditions can give a robust assumption for tilt amplification factor, which is shown in FIG. 4 to be approximately 7 in this case. Even if little or nothing is known about the subsurface fluid properties, which might be the case in a remote exploration area, FIG. 4 shows that a tilt amplification factor has a representative range of 4 to 10 if the immiscible fluid with density ρₒ is oil with api greater than 25 api. Plugging these parameter ranges into the expression for fluid contact tilt gives a fluid contact tilt range of 0.2°-0.5°.

In some implementations, subsurface structures can be many kilometers in extent. Therefore the effect of 0.5° fluid contact tilt can cause a vertical difference of 87 m over a distance of 10 km.

In some implementations, the inclination of the geological layers that form subsurface traps can be in the order of a few degrees, and fluid contacts that are tilted by angles of the same magnitude can lead to significantly different trapping potential than is apparent under the assumption of horizontal fluid contacts, due to the interaction of the tilted fluid contact with low inclination angles in the folded reservoir.

In some implementations, the fluid contact tilt range indicated above can be used as a starting point in screening for hydrodynamic traps because factors such as the presence of low density oil or higher hydraulic head gradients will greatly increase fluid contact tilt angle.

The representative range of fluid contact tile described above can be used to screen for the effects of fluid contact tilt, and therefore determine fluid distributions and inform decision making and drilling locations. An example usage of the representative range of fluid contact can include modeling the interaction of a geological structure, for example, a depth structure map, with an inclined, flat plane that represents a tilted fluid contact surface. The geological structure can then be rotated into a new reference frame where the inclined plane represents a horizontal fluid contact surface. Having transformed the geological structure, hydrodynamic traps can be identified in relation to this horizontal datum. The inclined plane and its impacts on the geological structure can be rapidly modeled by interactive software controls configured for example as sliders.

At 106, it is determined whether reservoir fluid density information and hydraulic head gradient information are available from the collected regional fluid information.

At 108, if it is determined that reservoir fluid density information or hydraulic head gradient information is not available from the collected regional fluid information, a tilt value of the fluid contact is set based at least on documented basin-scale analogs. In some implementations, some regional geological information, for example, basin shape and extent of porosity units, can be combined with documented basin-scale analogs to determine the orientation of the fluid contact surface.

At 110, if it is determined that reservoir fluid density information and hydraulic head gradient information are available from the collected regional fluid information, the tilt value of the fluid contact is set based at least on regional constraint such as the reservoir fluid density information and hydraulic head gradient information from the collected regional fluid information.

At 112, a tilt azimuth value of the fluid contact is set based at least on regional structure or the collected regional fluid information.

At 114, a planar model for the fluid contact is generated using the tilt value and the tilt azimuth values set in steps 108 to 112. The generated planar model represents the fluid contact tilt that can arise from a given hydraulic head gradient combined with the fluid density contrast between the targeted fluids and the pore waters. A range of tilt and azimuth can be used to represent the uncertainty associated with the tilt and tilt azimuth in the planar model.

At 116, the generated planar model and the depth structure map are combined to determine a hydrodynamic structure. In some implementations, a transformed depth structure map is first generated by rotating the depth structure map using a spatial reference frame associated with the generated planar model. This rotation flattens the fluid contact that was tilted in the depth structure map, enabling hydrodynamic traps in the area to be identified in the transformed depth structure map because, relative to the spatial reference frame, the hydrodynamic traps are of constant depth and therefore parallel to contours in the transformed depth structure map. An example of the transformed depth structure map is illustrated in FIG. 3C. The identified hydrodynamic traps and the depth structure map form the hydrodynamic structure.

In some implementations, the polygon in FIG. 3C indicates an example potential extent of hydrodynamic traps that can be determined based at least on a fit with existing well control. The hydrodynamic traps can be modeled manually, for example by isolating a specific closing contour, or it can be screened by going through a range of depth intervals within a user-specified area inside the limits of the depth structure map.

In some implementations, the two example interactive sliders illustrated in FIG. 3B can enable a user to specify tilt and tilt azimuth (tilt direction) associated with a fluid contact surface. The tilt contact surface orientation can be specified by the user based at least on what is known about the potentiometric surface in the reservoir of interest. The combination of the generated planar model of the fluid contact surface with the depth structure map, as shown in FIG. 3C, can be used to yield redatumed traps, i.e. hydrodynamic traps. If there is large uncertainty on the fluid contact surface orientation, different realizations can be made by rapidly adjusting the tilt and tilt azimuth of the planar model of the fluid contact surface using, for example, the sliders in FIG. 3B, in order to scan if hydrodynamic traps could exist in any hydrodynamic scenarios.

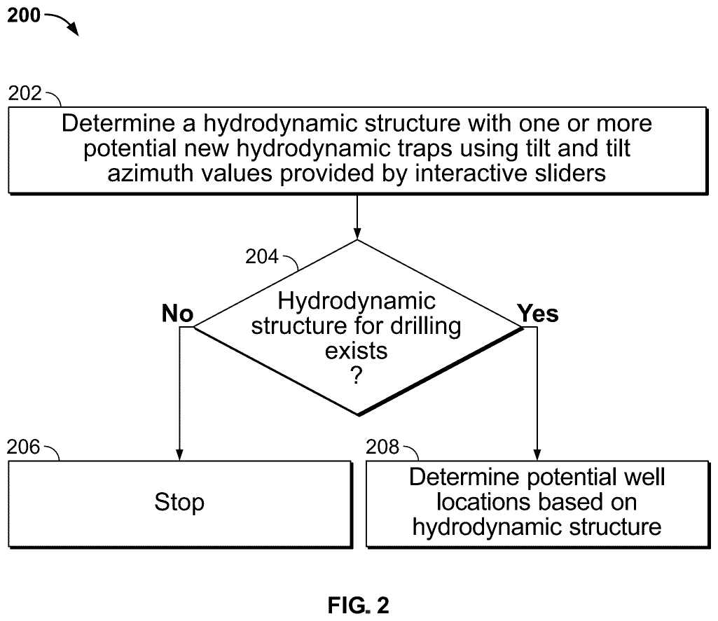

FIG. 2 depicts an example method 200 for determining potential well locations of an area associated with a depth structure map using tilt and tilt azimuth values provided by a user. In some implementations, the tilt and tilt azimuth values are associated with the orientation of a fluid contact surface and can be provided by two interactive sliders that are controlled by a user. Example interactive sliders providing tilt and tilt azimuth values are illustrated in FIG. 3B. Limits built into the slider ranges in FIG. 3B can represent the limits of hydraulic head gradient and fluid densities based at least on global or local knowledge. An example of a depth structure map is illustrated in FIG. 3A. FIGS. 3A-3D can be displayed simultaneously in a mapping application in order to enable a user to adjust the two interactive sliders in FIG. 2B while viewing the resulting maps in FIGS. 3C-3D.

At 202, a hydrodynamic structure with one or more potential new hydrodynamic traps is determined using multiple pairs of tilt and tilt azimuth values provided by a user, for example, through the two example interactive sliders in FIG. 3B. Each pair of tilt and tilt azimuth values can represent an assumed pair of tilt and tilt azimuth values associated with the fluid contact of an oil accumulation in the area. In some implementations, the hydrodynamic structure can include the depth structure map illustrated in FIG. 3A, with the addition of the one or more potential new hydrodynamic traps.

In some implementations, each pair of tilt and tilt azimuth values can be provided by two interactive slides controlled by a user. The pair of tilt and tilt azimuth values can be used to determine a respective planar model using the method described in step 114 of FIG. 1, with the initial tilt and tilt azimuth values replaced by the pair of tilt and tilt azimuth values provided by the user through the two interactive sliders. The determined planar model can then be combined with the depth structure map using the method described in step 116 to generate a transformed depth structure map. As described in step 116 of FIG. 1, the transformed depth structure map is the depth structure map rotated using a spatial reference frame determined by the pair of tilt and tilt azimuth values. This rotation flattens the fluid contact that was tilted in the depth structure map, enabling hydrodynamic traps in the area to be identified in the transformed depth structure map because, relative to the spatial reference frame, the hydrodynamic traps are of constant depth and therefore parallel to contours in the transformed depth structure map. An example of the transformed depth structure map is illustrated in FIG. 3C.

In some implementations, for each pair of tilt and tilt azimuth values provided by the user through the two interactive sliders, the hydrodynamic traps identified in the transformed depth structure map generated by the pair of tilt and tilt azimuth values and the depth structure map can be added to the depth structure map. An example of adding identified hydrodynamic traps to the depth structure map is illustrated in FIG. 3D, where the existing field extent illustrated in the depth structure map in FIG. 3A (the polygon) can be compared to identified hydrodynamic traps, for example, the spot for new well option in FIG. 3D.

In some implementations, additional transformed depth structure maps can be generated rapidly using additional pairs of tilt and tilt azimuth values provided by the user through the interactive sliders, with each additional transformed depth structure map having identified hydrodynamic traps that are added to the depth structure map. If there are one or more hydrodynamic traps identified in all transformed depth structure maps, a hydrodynamic structure can be determined by adding the one or more identified hydrodynamic traps to the depth structure map.

At 204, it is determined whether one or more hydrodynamic traps are identified in all transformed depth structure maps generated in step 202, and if one or more hydrodynamic traps are identified in all transformed depth structure maps generated in step 202, it is determined that a hydrodynamic structure for drilling exists. This hydrodynamic structure is formed by adding the one or more identified hydrodynamic traps to the depth structure map. If no hydrodynamic trap exists in all transformed depth structure maps generated in step 202, it is determined that no hydrodynamic structure for drilling exists.

At 206, if it is determined that no hydrodynamic structure for drilling exists, the process for determining potential well locations stops.

At 208, if it is determined that a hydrodynamic structure for drilling exists, as described in step 204, the one or more hydrodynamic traps that are identified in all transformed depth structure maps generated in step 202 can be determined to be potential well locations.

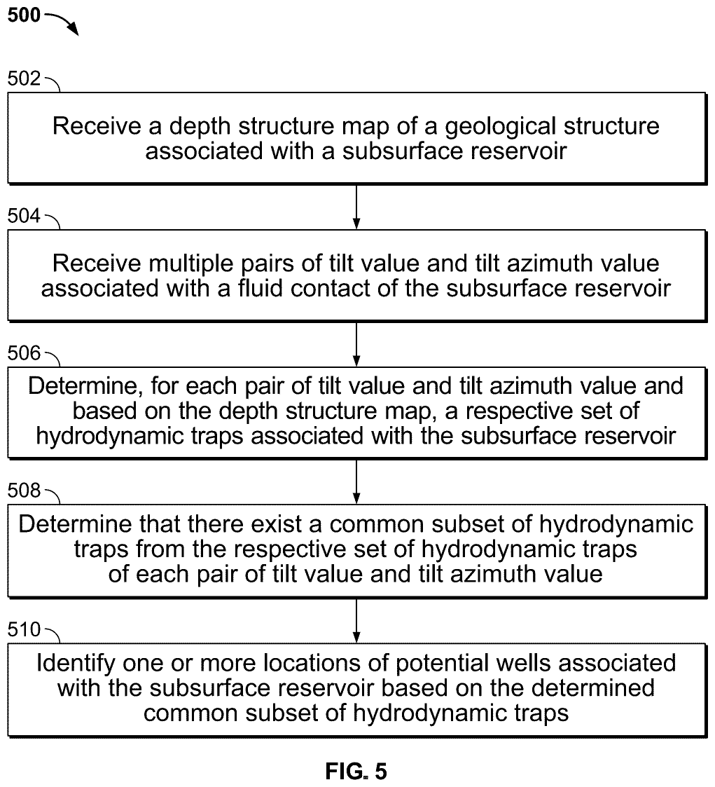

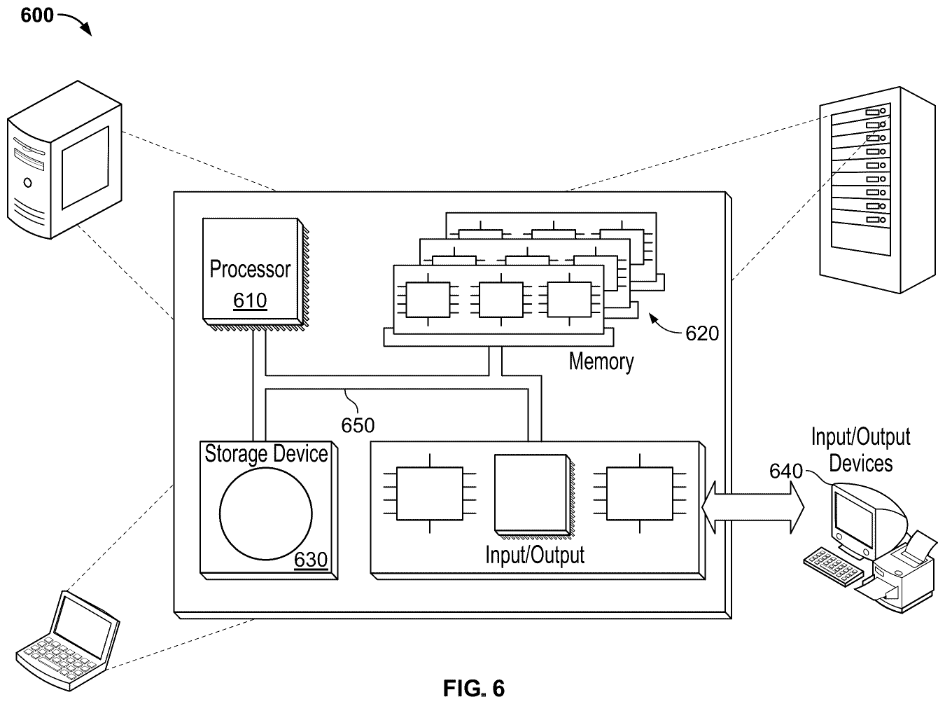

FIG. 5 illustrates an example method 500 for rapidly identifying hydrodynamic traps in hydrocarbon reservoirs. For convenience, the method 500 will be described as being performed by a system of one or more computers, located in one or more locations, and programmed appropriately in accordance with this specification.

At 502, a computer system receives a depth structure map of a geological structure associated with a subsurface reservoir.

At 504, the computer system receives multiple pairs of tilt value and tilt azimuth value associated with a fluid contact of the subsurface reservoir.

At 506, the computer system determines, for each pair of tilt value and tilt azimuth value and based at least on the depth structure map, a respective set of hydrodynamic traps associated with the subsurface reservoir.

At 508, the computer system determines that there exist a common subset of hydrodynamic traps from the respective set of hydrodynamic traps of each pair of tilt value and tilt azimuth value.

At 510, the computer system identifies one or more locations of potential wells associated with the subsurface reservoir based at least on the determined common subset of hydrodynamic traps.

FIG. 6 illustrates a schematic diagram of an example computing system 600. The system 600 can be used for the operations described in association with the implementations described herein. For example, the system 600 may be included in any or all of the server components discussed herein. The system 600 includes a processor 610, a memory 620, a storage device 630, and an input/output device 640. The components 610, 620, 630, and 640 are interconnected using a system bus 650. The processor 610 is capable of processing instructions for execution within the system 600. In some implementations, the processor 610 is a single-threaded processor. The processor 610 is a multi-threaded processor. The processor 610 is capable of processing instructions stored in the memory 620 or on the storage device 630 to display graphical information for a user interface on the input/output device 640.

The memory 620 stores information within the system 600. In some implementations, the memory 620 is a computer-readable medium. The memory 620 is a volatile memory unit. The memory 620 is a non-volatile memory unit. The storage device 630 is capable of providing mass storage for the system 600. The storage device 630 is a computer-readable medium. The storage device 630 may be a floppy disk device, a hard disk device, an optical disk device, or a tape device. The input/output device 640 provides input/output operations for the system 600. The input/output device 640 includes a keyboard and/or pointing device. The input/output device 640 includes a display unit for displaying graphical user interfaces.

Certain aspects of the subject matter described here can be implemented as a method. A depth structure map of a geological structure associated with a subsurface reservoir is received. Multiple pairs of tilt value and tilt azimuth value associated with a fluid contact of the subsurface reservoir are received. A respective set of hydrodynamic traps associated with the subsurface reservoir is determined for each pair of tilt value and tilt azimuth value and based at least on the depth structure map. It is determined that there exist a common subset of hydrodynamic traps from the respective set of hydrodynamic traps of each pair of tilt value and tilt azimuth value. One or more locations of potential wells associated with the subsurface reservoir are identified based at least on the determined common subset of hydrodynamic traps.

An aspect taken alone or combinable with any other aspect includes the following features. Receiving the multiple pairs of tilt value and tilt azimuth value associated with the fluid contact of the subsurface reservoir includes receiving, from a user and through two interactive sliders displayed on a mapping application, the multiple pairs of tilt value and tilt azimuth value, where the two interactive sliders are controlled by the user.

An aspect taken alone or combinable with any other aspect includes the following features. Determining, for each pair of tilt value and tilt azimuth value and based at least on the depth structure map, the respective set of hydrodynamic traps associated with the subsurface reservoir includes determining a respective two-dimensional plane based at least on each pair of tilt value and tilt azimuth value, determining a respective transformed depth structure map by rotating the depth structure map using the respective two-dimensional plane, and determining the respective set of hydrodynamic traps based at least on the respective transformed depth structure map.

An aspect taken alone or combinable with any other aspect includes the following features. Identifying the one or more locations of potential wells associated with the subsurface reservoir based at least on the determined common subset of hydrodynamic traps includes identifying the one or more locations of potential wells associated with the subsurface reservoir as locations of the determined common subset of hydrodynamic traps.

An aspect taken alone or combinable with any other aspect includes the following features. The depth structure map includes a tilted fluid contact in the subsurface reservoir.

An aspect taken alone or combinable with any other aspect includes the following features. Each tilt value in the multiple pairs of tilt value and tilt azimuth value is within a first range determined by fluid density information from one or more wells of the subsurface reservoir.

An aspect taken alone or combinable with any other aspect includes the following features. The first range is further determined by hydraulic head gradient information from the one or more wells of the subsurface reservoir.

Certain aspects of the subject matter described in this disclosure can be implemented as a non-transitory computer-readable medium storing instructions which, when executed by a hardware-based processor perform operations including the methods described here.

Certain aspects of the subject matter described in this disclosure can be implemented as a computer-implemented system that includes one or more processors including a hardware-based processor, and a memory storage including a non-transitory computer-readable medium storing instructions which, when executed by the one or more processors performs operations including the methods described here.

Implementations and all of the functional operations described in this specification may be realized in digital electronic circuitry, or in computer software, firmware, or hardware, including the structures disclosed in this specification and their structural equivalents, or in combinations of one or more of them. Implementations may be realized as one or more computer program products (i.e., one or more modules of computer program instructions encoded on a computer readable medium for execution by, or to control the operation of, data processing apparatus). The computer readable medium may be a machine-readable storage device, a machine-readable storage substrate, a memory device, a composition of matter effecting a machine-readable propagated signal, or a combination of one or more of them. The term “computing system” encompasses all apparatus, devices, and machines for processing data, including by way of example a programmable processor, a computer, or multiple processors or computers. The apparatus may include, in addition to hardware, code that creates an execution environment for the computer program in question (e.g., code that constitutes processor firmware, a protocol stack, a database management system, an operating system, or any appropriate combination of one or more thereof). A propagated signal is an artificially generated signal (e.g., a machine-generated electrical, optical, or electromagnetic signal) that is generated to encode information for transmission to suitable receiver apparatus.

A computer program (also known as a program, software, software application, script, or code) may be written in any appropriate form of programming language, including compiled or interpreted languages, and it may be deployed in any appropriate form, including as a stand-alone program or as a module, component, subroutine, or other unit suitable for use in a computing environment. A computer program does not necessarily correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one computer or on multiple computers that are located at one site or distributed across multiple sites and interconnected by a communication network.

The processes and logic flows described in this specification may be performed by one or more programmable processors executing one or more computer programs to perform functions by operating on input data and generating output. The processes and logic flows may also be performed by, and apparatus may also be implemented as, special purpose logic circuitry (e.g., an FPGA (field programmable gate array) or an ASIC (application specific integrated circuit)).

Processors suitable for the execution of a computer program include, by way of example, both general and special purpose microprocessors, and any one or more processors of any appropriate kind of digital computer. Generally, a processor will receive instructions and data from a read only memory or a random access memory or both. Elements of a computer can include a processor for performing instructions and one or more memory devices for storing instructions and data. Generally, a computer will also include, or be operatively coupled to receive data from or transfer data to, or both, one or more mass storage devices for storing data (e.g., magnetic, magneto optical disks, or optical disks). However, a computer need not have such devices. Moreover, a computer may be embedded in another device (e.g., a mobile telephone, a personal digital assistant (PDA), a mobile audio player, a Global Positioning System (GPS) receiver). Computer readable media suitable for storing computer program instructions and data include all forms of non-volatile memory, media and memory devices, including by way of example semiconductor memory devices (e.g., EPROM, EEPROM, and flash memory devices); magnetic disks (e.g., internal hard disks or removable disks); magneto optical disks; and CD ROM and DVD-ROM disks. The processor and the memory may be supplemented by, or incorporated in, special purpose logic circuitry.

To provide for interaction with a user, implementations may be realized on a computer having a display device (e.g., a CRT (cathode ray tube), LCD (liquid crystal display) monitor) for displaying information to the user and a keyboard and a pointing device (e.g., a mouse, a trackball, a touch-pad), by which the user may provide input to the computer. Other kinds of devices may be used to provide for interaction with a user as well; for example, feedback provided to the user may be any appropriate form of sensory feedback (e.g., visual feedback, auditory feedback, tactile feedback); and input from the user may be received in any appropriate form, including acoustic, speech, or tactile input.

Implementations may be realized in a computing system that includes a back end component (e.g., as a data server), a middleware component (e.g., an application server), and/or a front end component (e.g., a client computer having a graphical user interface or a Web browser, through which a user may interact with an implementation), or any appropriate combination of one or more such back end, middleware, or front end components. The components of the system may be interconnected by any appropriate form or medium of digital data communication (e.g., a communication network). Examples of communication networks include a local area network (“LAN”) and a wide area network (“WAN”), e.g., the Internet.

The computing system may include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of the disclosure or of what may be claimed, but rather as descriptions of features specific to particular implementations. Certain features that are described in this specification in the context of separate implementations may also be implemented in combination in a single implementation. Conversely, various features that are described in the context of a single implementation may also be implemented in multiple implementations separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products.

A number of implementations have been described. Nevertheless, it will be understood that various modifications may be made without departing from the spirit and scope of the disclosure. For example, various forms of the flows shown above may be used, with steps re-ordered, added, or removed. Accordingly, other implementations are within the scope of the following claims.

What is claimed is:

1. A computer-implemented method, comprising:
receiving a depth structure map of a geological structure associated with a subsurface reservoir;
receiving a plurality pairs of tilt value and tilt azimuth value associated with a fluid contact of the subsurface reservoir;
determining, for each pair of tilt value and tilt azimuth value and based at least on the depth structure map, a respective set of hydrodynamic traps associated with the subsurface reservoir;
determining that there exist a common subset of hydrodynamic traps from the respective set of hydrodynamic traps of each pair of tilt value and tilt azimuth value; and
identifying one or more locations of potential wells associated with the subsurface reservoir based at least on the determined common subset of hydrodynamic traps.

2. The computer-implemented method of claim 1, wherein receiving the plurality pairs of tilt value and tilt azimuth value associated with the fluid contact of the subsurface reservoir comprises:
receiving, from a user and through two interactive sliders displayed on a mapping application, the plurality pairs of tilt value and tilt azimuth value, wherein the two interactive sliders are controlled by the user.

3. The computer-implemented method of claim 1, wherein determining, for each pair of tilt value and tilt azimuth value and based at least on the depth structure map, the respective set of hydrodynamic traps associated with the subsurface reservoir comprises:
determining a respective two-dimensional plane based at least on each pair of tilt value and tilt azimuth value;
determining a respective transformed depth structure map by rotating the depth structure map using the respective two-dimensional plane; and
determining the respective set of hydrodynamic traps based at least on the respective transformed depth structure map.

4. The computer-implemented method of claim 1, wherein identifying the one or more locations of potential wells associated with the subsurface reservoir based at least on the determined common subset of hydrodynamic traps comprises:
identifying the one or more locations of potential wells associated with the subsurface reservoir as locations of the determined common subset of hydrodynamic traps.

5. The computer-implemented method of claim 1, wherein the depth structure map comprises a tilted fluid contact in the subsurface reservoir.

6. The computer-implemented method of claim 1, wherein each tilt value in the plurality pairs of tilt value and tilt azimuth value is within a first range determined by fluid density information from one or more wells of the subsurface reservoir.

7. The computer-implemented method of claim 6, wherein the first range is further determined by hydraulic head gradient information from the one or more wells of the subsurface reservoir.

8. A non-transitory, computer-readable medium storing one or more instructions executable by a computer system to perform operations comprising:
receiving a depth structure map of a geological structure associated with a subsurface reservoir;
receiving a plurality pairs of tilt value and tilt azimuth value associated with a fluid contact of the subsurface reservoir;
determining, for each pair of tilt value and tilt azimuth value and based at least on the depth structure map, a respective set of hydrodynamic traps associated with the subsurface reservoir;
determining that there exist a common subset of hydrodynamic traps from the respective set of hydrodynamic traps of each pair of tilt value and tilt azimuth value; and
identifying one or more locations of potential wells associated with the subsurface reservoir based at least on the determined common subset of hydrodynamic traps.

9. The non-transitory, computer-readable medium of claim 8, wherein receiving the plurality pairs of tilt value and tilt azimuth value associated with the fluid contact of the subsurface reservoir comprises:
receiving, from a user and through two interactive sliders displayed on a mapping application, the plurality pairs of tilt value and tilt azimuth value, wherein the two interactive sliders are controlled by the user.

10. The non-transitory, computer-readable medium of claim 8, wherein determining, for each pair of tilt value and tilt azimuth value and based at least on the depth structure map, the respective set of hydrodynamic traps associated with the subsurface reservoir comprises:
determining a respective two-dimensional plane based at least on each pair of tilt value and tilt azimuth value;
determining a respective transformed depth structure map by rotating the depth structure map using the respective two-dimensional plane; and
determining the respective set of hydrodynamic traps based at least on the respective transformed depth structure map.

11. The non-transitory, computer-readable medium of claim 8, wherein identifying the one or more locations of potential wells associated with the subsurface reservoir based at least on the determined common subset of hydrodynamic traps comprises:
identifying the one or more locations of potential wells associated with the subsurface reservoir as locations of the determined common subset of hydrodynamic traps.

12. The non-transitory, computer-readable medium of claim 8, wherein the depth structure map comprises a tilted fluid contact in the subsurface reservoir.

13. The non-transitory, computer-readable medium of claim 8, wherein each tilt value in the plurality pairs of tilt value and tilt azimuth value is within a first range determined by fluid density information from one or more wells of the subsurface reservoir.

14. The non-transitory, computer-readable medium of claim 13, wherein the first range is further determined by hydraulic head gradient information from the one or more wells of the subsurface reservoir.

15. A computer-implemented system, comprising:
one or more computers; and
one or more computer memory devices interoperably coupled with the one or more computers and having tangible, non-transitory, machine-readable media storing one or more instructions that, when executed by the one or more computers, perform one or more operations comprising:
receiving a depth structure map of a geological structure associated with a subsurface reservoir;
receiving a plurality pairs of tilt value and tilt azimuth value associated with a fluid contact of the subsurface reservoir;
determining, for each pair of tilt value and tilt azimuth value and based at least on the depth structure map, a respective set of hydrodynamic traps associated with the subsurface reservoir;
determining that there exist a common subset of hydrodynamic traps from the respective set of hydrodynamic traps of each pair of tilt value and tilt azimuth value; and
identifying one or more locations of potential wells associated with the subsurface reservoir based at least on the determined common subset of hydrodynamic traps.

16. The computer-implemented system of claim 15, wherein receiving the plurality pairs of tilt value and tilt azimuth value associated with the fluid contact of the subsurface reservoir comprises:
receiving, from a user and through two interactive sliders displayed on a mapping application, the plurality pairs of tilt value and tilt azimuth value, wherein the two interactive sliders are controlled by the user.

17. The computer-implemented system of claim 15, wherein determining, for each pair of tilt value and tilt azimuth value and based at least on the depth structure map, the respective set of hydrodynamic traps associated with the subsurface reservoir comprises:
determining a respective two-dimensional plane based at least on each pair of tilt value and tilt azimuth value;
determining a respective transformed depth structure map by rotating the depth structure map using the respective two-dimensional plane; and
determining the respective set of hydrodynamic traps based at least on the respective transformed depth structure map.

18. The computer-implemented system of claim 15, wherein identifying the one or more locations of potential wells associated with the subsurface reservoir based at least on the determined common subset of hydrodynamic traps comprises:
identifying the one or more locations of potential wells associated with the subsurface reservoir as locations of the determined common subset of hydrodynamic traps.

19. The computer-implemented system of claim 15, wherein the depth structure map comprises a tilted fluid contact in the subsurface reservoir.

20. The computer-implemented system of claim 15, wherein each tilt value in the plurality pairs of tilt value and tilt azimuth value is within a first range determined by fluid density information from one or more wells of the subsurface reservoir.
